(19) United States
(12) Patent Application Publication
(10) Pub. No.: US 2003/0073056 A1
(43) Pub. Date: Apr. 17, 2003

(54) Shock generating device for simulation gun

(76) Inventor: Buhm Kim, Kyunggi-do (KR)

Correspondence Address: MARSHALL, GERSTEIN & BORUN, 6300 SEARS TOWER, 233 SOUTH WACKER, CHICAGO, IL, 60606-6357, US

(21) Appl. No.: 10/033,677

(22) Filed: Dec. 27, 2001

(30) Foreign Application Priority Data
Jun. 8, 2001 (KR) 2001-31985

(51) Int. Cl. F41G 3/26; G09B 19/00; F41A 33/00

(52) U.S. Cl. 434/16

(57) ABSTRACT

There is provided a shock generating device for a simulation gun. A hollow rod is inserted into the cylindrical housing. A shaft is installed in the lengthwise direction inside the housing movably and coaxially along with the hollow rod. One end of a spring is inserted into the hollow rod and the other end, supported by a predetermined cap mounted on the housing. A driven gear is integrated with a hollow cam shaft with a spiral inclined portion and mounted on the cap. A key of the shaft prevents the deviation of the driven gear from the shaft and moves the shaft in the length direction along the spiral inclined portion upon rotation of the hollow cam shaft. A driving device is installed at a side of the housing and has a driving gear engaged with the driven gear.

This application claims priority to an application entitled “Shock Generating Device for Simulation Gun” filed in the Korean Industrial Property Office on Jun. 8, 2001 and assigned Serial No. 2001-31985, the contents of which are hereby incorporated by reference.

### BACKGROUND OF THE INVENTION

1. Field of the Invention

The present invention relates generally to a simulation gun for use in simulated shooting, electronic gaming, and the like, and in particular, to a shock generating device for a simulation gun to generate shocks to the gun when the trigger of the gun is pulled and thus to give a gun player a sense of real shooting.

2. Description of the Related Art

The recent development in the game industry has introduced diverse types of game devices from real life. The major ones include simulation guns for use in a simulated shooting game and a sports shooting.

The simulation guns are used compatibly with the existing game devices and through a PC or TV monitor, they can be utilized to play games such as shooting or hunting with the aid of software programs. Those games attract much attention.

A simulation gun is different in structure from a real gun. For example, the simulation gun is so configured as to exchange signals with a monitor or a set-top box to shoot a target. Thus, a shooting game device has a screen that provides vivid three-dimensional images and a speaker that reproduces live sounds.

However, the conventional simulation gun has limitations in offering a sense of real shooting due to lack of shocks to the body of a game player when he pulls the trigger of the gun. Even though the gun is provided with a shock generating device, the shock generating device operates merely mechanically according to the manipulation of the trigger of the gun. As a result, frequent use of the simulation gun causes mechanical abrasion-incurred malfunction and thus increases user dissatisfaction.

### SUMMARY OF THE INVENTION

The present invention can be achieved by providing a shock generating device for a simulation gun. According to one aspect of the present invention, a shock generating device includes a cylindrical housing, a hollow rod, a shaft of a predetermined length, a spring, a driven gear integrated with a hollow cam shaft having a spiral inclined portion, a key inserted into a key groove to be protruding, perpendicularly to the axial direction, from the outer circumferential surface of the shaft, and a driving device at a side of the housing. The hollow rod is inserted into the cylindrical housing. The shaft is installed movably in its lengthwise direction inside the housing along with the hollow rod and coaxially with the hollow rod. The spring has one end with predetermined elasticity to be inserted into the hollow rod and the other end to be supported by a cap mounted on the housing. The shaft is fit into the spring. The driven gear is mounted on the cap for inserting the shaft therethrough. The key functions to prevent the deviation of the driven gear from the shaft and to move the shaft along the spiral inclined portion in the length direction upon rotation of the hollow cam shaft. The driving device has a driving gear to be engaged with the driven gear.

According to another aspect of the present invention, in a shock generating device, a driving motor is installed outside the housing and has a rotating shaft protruding inside the housing. A first gear is fixed to the rotating shaft of the driving motor. A two-stepped gear has a second gear receiving the rotating force of the first gear and a third gear integrally formed with the second gear around the same axis. A fourth gear is installed to receive the rotating force of the second and third gears. A hook is integrated coaxially with the fourth gear and extended to the outer circumferential surface of the fourth gear. A lever has a body that contacts the inner wall of the housing, a free end extended from the body to the rotating radius of the hook, and a fixed end extended from the body and rotatably fixed on the housing by a hinge pin. The body, the free end, and the fixed end are integrally formed. An elastic member presses the body of the lever to contact the inner wall of the housing.

### BRIEF DESCRIPTION OF THE DRAWINGS

The features and advantages of the present invention will become more apparent from the following detailed description when taken in conjunction with the accompanying drawings in which:

FIG. 1 is a plan view of a simulation gun according to a preferred embodiment of the present invention;

FIG. 2 is an exploded perspective view of a shock generating device for the simulation gun according to the preferred embodiment of the present invention;

FIG. 3 is a perspective view of a hollow cam shaft integrated with a driven gear according to the preferred embodiment of the present invention;

FIG. 4 is a combined perspective view of the shock generating device according to the preferred embodiment of the present invention;

FIG. 5 is a sectional view of the shock generating device in an assembled state according to the preferred embodiment of the present invention;

FIG. 6 is a sectional view of the shock generating device when a shaft is placed at the peak point of a cam portion according to the preferred embodiment of the present invention;

FIG. 7 is a perspective view of a shock generating device according to another preferred embodiment of the present invention;

FIG. 8 is a sectional view of the shock generating device according to the second preferred embodiment of the present invention; and

FIG. 9 is a sectional view of the shock generating device according to the second preferred embodiment of the present invention, referred to for describing its shock generating operation.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail since they would obscure the invention in unnecessary detail.

A shock generating device for a simulation gun according to the present invention is described in two embodiments. In both embodiments, the shock generating device employs a shock generation mechanism in which when a game player pulls the trigger of the gun, power is supplied to a motor device upon electrical connection and drives a driving device, to thereby produce shocks automatically.

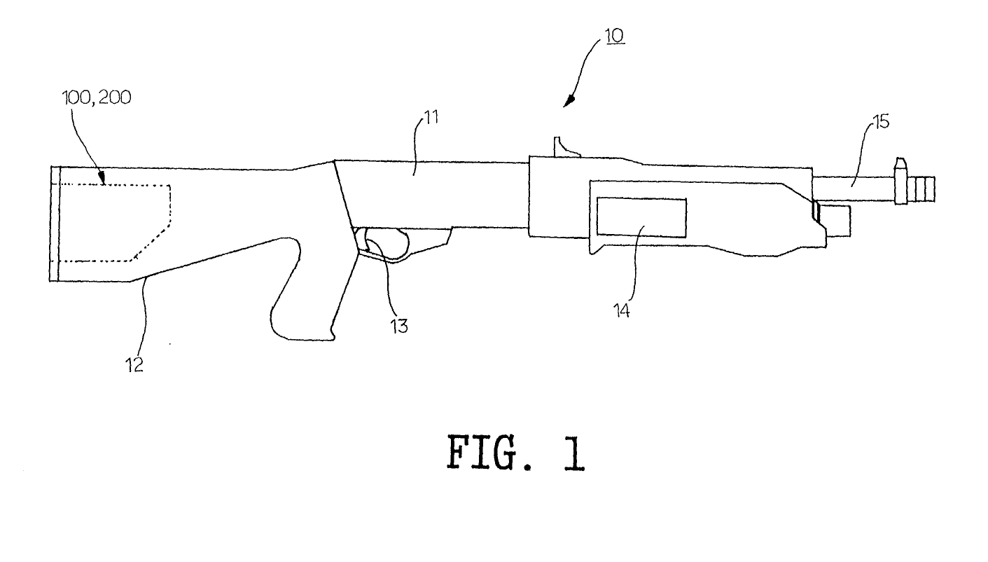

FIG. 1 is a plan view of a simulation gun according to a preferred embodiment of the present invention. Although the gun is a rifle in FIG. 1, any other kind of gun can be adopted.

Referring to FIG. 1, a simulation gun 10 includes a body 11, a stock 12 at the rear of the body 11, and a barrel 15 at the front of the body 11. A trigger 13 is disposed as a firing device under the body 11 and a control panel 14 is provided at a portion of the body 11 to control the operation mode of the simulation gun 10. It is preferable to further include a laser beam device (not shown) with a light emitting portion and a light receiving portion at the barrel 15.

Since a shock generating device according to the present invention is installed at the stock of a simulation gun, a game player can feel a sense of real shooting when he shoots a target with the gun shouldered.

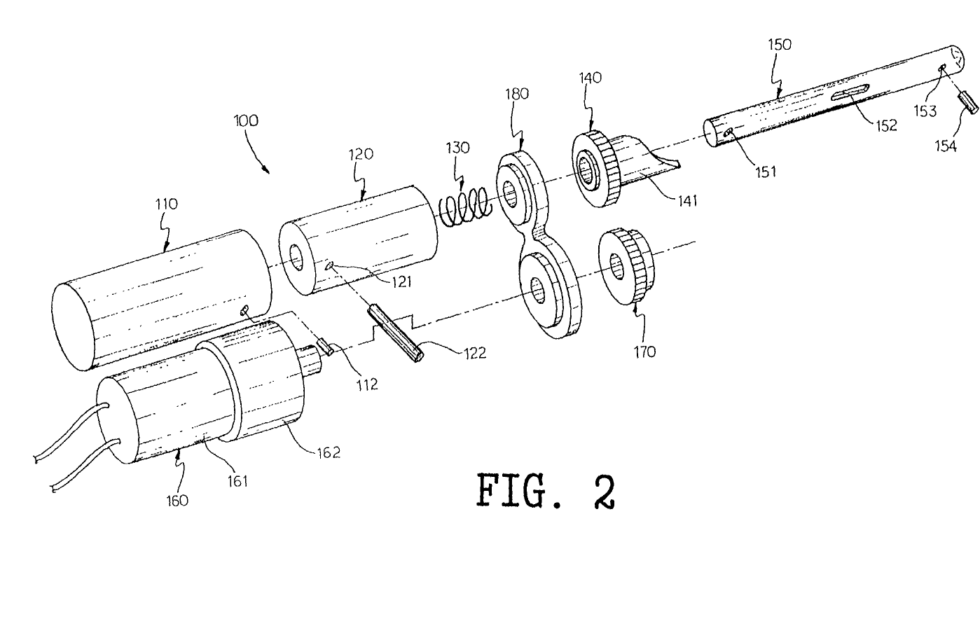

FIG. 2 is an exploded perspective view of a shock generating device for the simulation gun according to the preferred embodiment of the present invention. Referring to FIG. 2, a shock generating device 100 is comprised of a cylindrical housing 110, a hollow rod 120, a shaft 150 of a predetermined length, a spring 130, a driven gear 140 integrated with a hollow cam shaft 141 having a spiral inclined portion, a key 154 inserted into a key groove 153 to be protruding, perpendicularly to the axial direction, from the outer circumferential surface of the shaft 150, and a driving device 160 at a side of the housing 110. The hollow rod 120 is inserted into the cylindrical housing 110. The shaft 150 is installed movably in its lengthwise direction inside the housing 110 along with the hollow rod 120 and coaxially with the hollow rod 120. The spring 130 has one end with predetermined elasticity to be inserted into the hollow rod 120 and the other end to be supported by a cap 180 mounted on the housing 110. The shaft 150 is fit into the spring 130. The driven gear 140 is mounted on the cap 180 for inserting the shaft 150 therethrough. The key 154 functions to prevent the deviation of the driven gear 140 from the shaft 150 and to move the shaft 150 along the spiral inclined portion in the length direction upon rotation of the hollow cam shaft 141. The driving device 160 has a driving gear 170 to be engaged with the driven gear 140.

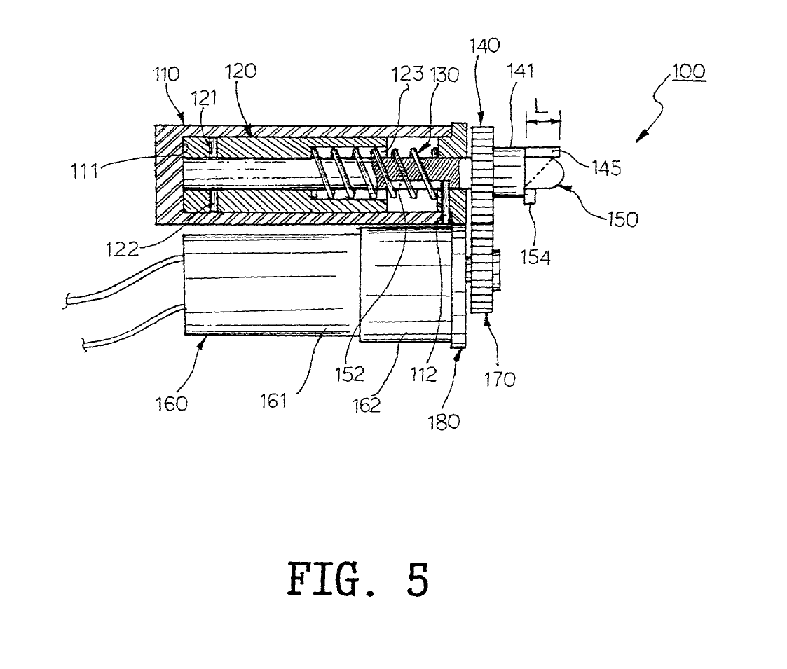

A spring insertion hole (123 of FIG. 5) having a larger diameter than a hole for holding the shaft 150 is formed in the hollow rod 120. The spring 130 is inserted into the spring insertion hole and applies pressure to the hollow rod 120. A hole 121 is formed to penetrate the side surfaces of the hollow rod 120 so that after the shaft 150 is inserted into the hollow rod 120, a fixing pin 122 fixes the shaft 150 within the hollow rod 120 through the holes 121 and 151 and thus the shaft 150 and the hollow rod 120 move together.

A guide slit 152 of a predetermined length is formed lengthwise at an appropriate portion of the outer circumferential surface of the shaft 150, and a guide pin 112 is inserted into the guide slit 152, protruding inward from the housing 110 to guide the motion of the shaft 150 along the axial direction.

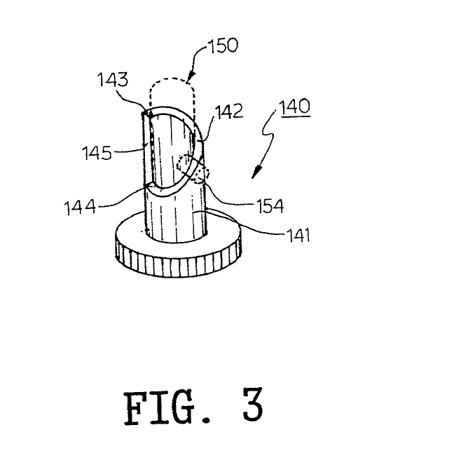

As shown in FIG. 3, the hollow cam shaft 141 of the driven gear 140 has a peak point 143 defined at an end of the spiral inclined portion 142, and a falling portion 145 is extended from the peak point 143. As the driven gear 140 rotates, the key 154 of the shaft 150 is guided from a bottom point 144 to the peak point 143 and vice versa via the falling portion 145. Thus, the shaft 150 makes reciprocation for a predetermined length along the axial direction. When the key 154 of the shaft 150 falls from the peak point 143 to the bottom point 144 along the falling portion 145 of the driven gear 140, the lower surface of the hollow rod 120 moving with the shaft 150 bumps against the inner lower surface (111 of FIG. 5) of the housing 110 due to the elastic force of the spring 130, thereby producing shocks.

When the trigger is pulled once, the driving device 160 rotates the driven gear 140 once by the driving gear 170, thus producing one shock. Here, the driving device 160 may include a driving motor 161 and a deceleration module 162 with a plurality of gears in combination.

The cap 180 mounted on the housing 110 is integrated with a cap 180 mounted on the deceleration module 162 of the driving device 160 and the driving gear 170 is engaged with the driven gear 140, so that the housing 10 and the driving device 160 are assembled into one structure.

To increase shocks when the hollow rod 120 and the shaft 150 bump against the housing 110, the hollow rod 120 and the shaft 150 are formed of a heavy weight metal, preferably, steel or copper resistant to rust. The spring 130 is a compressed coil spring.

FIG. 3 is a perspective view of the hollow cam shaft integrated with the driven gear according to the preferred embodiment of the present invention. The inside of the hollow cam shaft 141 is hollow coaxially with the driven gear 140. As described before, the hollow cam shaft 141 has the spiral inclined portion 142, the peak point 143 on the inclined portion 142, the bottom point 144 connected to the peak point 143, and the falling portion 145 connecting the peak point 143 and the bottom point 144. As the key 154 of the shaft 150 moves from the peak point 143 to the bottom point 144 along the inclined portion 142, the driven gear 160 makes one revolution. Therefore, the shaft 150 makes a linear movement between the peak point 143 and the bottom point 144, that is, for the linear length of the falling portion 145, which is the movement distance of the hollow rod 120 moving with the shaft 150.

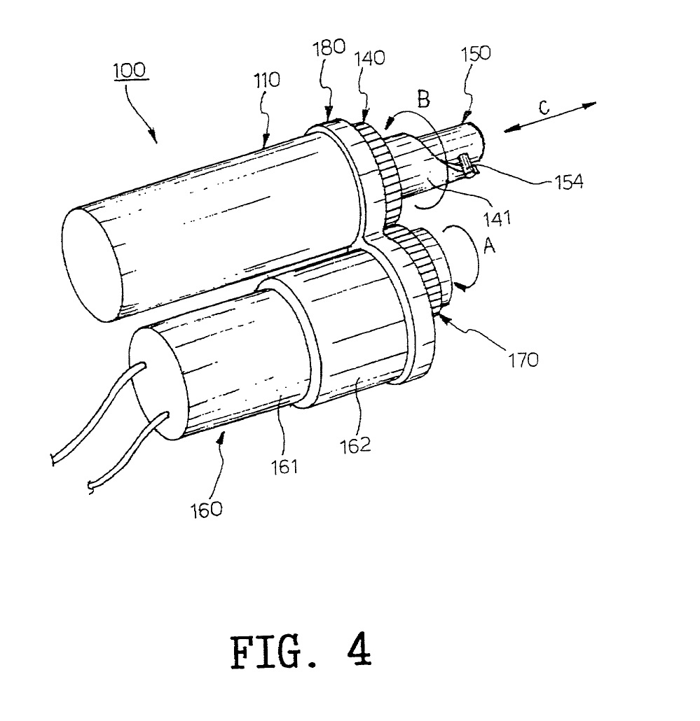

FIG. 4 is a combined perspective view of the shock generating device 100 according to the preferred embodiment of the present invention. Referring to FIG. 4, as the driving gear 170 of the driving device 160 rotates in a direction A, the driven gear 140 in engagement with the driving gear 170 rotates in a direction B and then the key 154 of the shaft 150 moves along the inclined portion 142 of the hollow cam shaft 141. As a result, the shaft 150 moves in a direction C, that is, only along the axis direction of the driven gear 140.

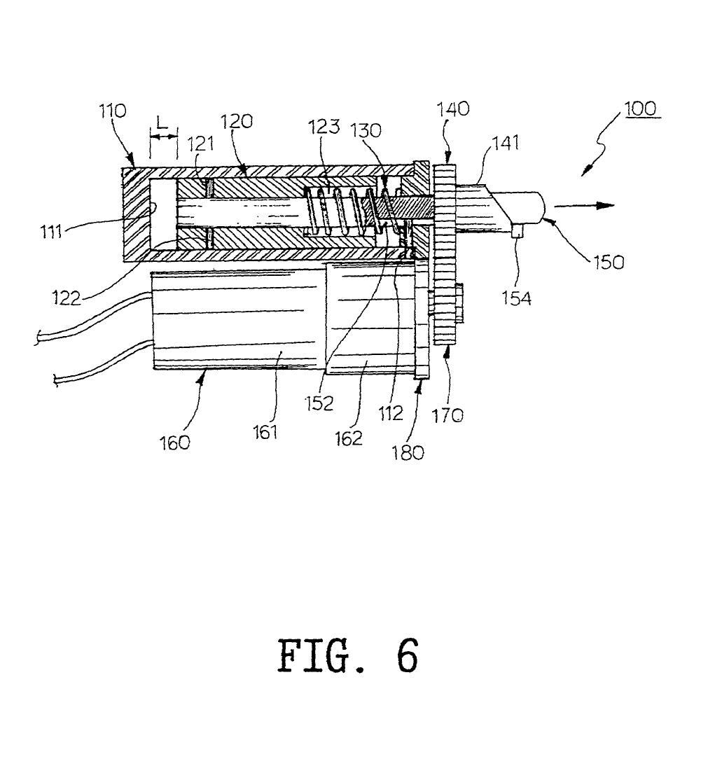

FIG. 5 is a sectional view of the shock generating device in an assembled state and FIG. 6 is a sectional view of the shock generating device with the shaft 150 at the peak point of the hollow cam shaft 141 according to the preferred embodiment of the present invention. Referring to FIGS. 5 and 6, as the driven gear 140 rotates by the driving force of the driving device 160, the key 154 of the shaft 150 moves from the bottom point to the peak point along the inclined portion of the hollow cam shaft 141. When the key 154 reaches the peak point of the hollow cam shaft 141, the hollow rod 120 moves for the length L of the falling portion shown in FIG. 5 along the axial direction. At the same time, the guide pin 112 of the housing 110 moves along the guide slit 152 of the shaft 150, so that the shaft 150 makes only an axial movement without rotation. In this case, the spring 130 is maximally compressed.

If the driven gear 140 further rotates with the key 154 of the shaft 150 at the peak point, the driven gear 140 reaches the falling portion 145 and then drops to the bottom point. At the same time, the pressure held by the spring 130 is applied to the hollow rod 120 and then the lower surface of the hollow rod 120 hits the inner lower surface 111 of the housing 110, producing shocks.

Meanwhile, if the game player continues switching the firing device, shocks are produced in a cycle as the key 154 of the shaft 150 moves from the bottom point to the peak point along the inclined portion of the hollow cam shaft 141 and then drops to the bottom point instantaneously.

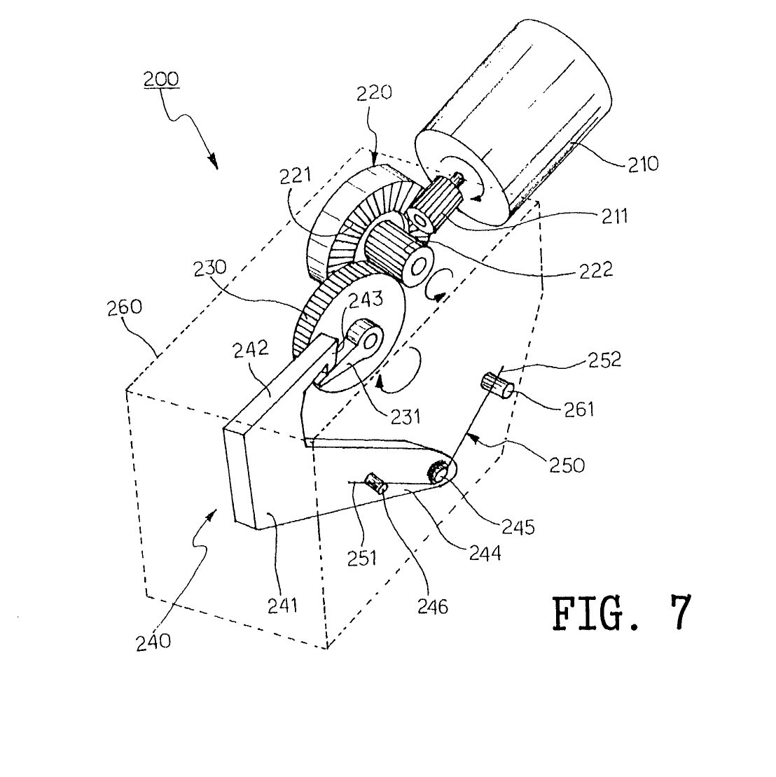

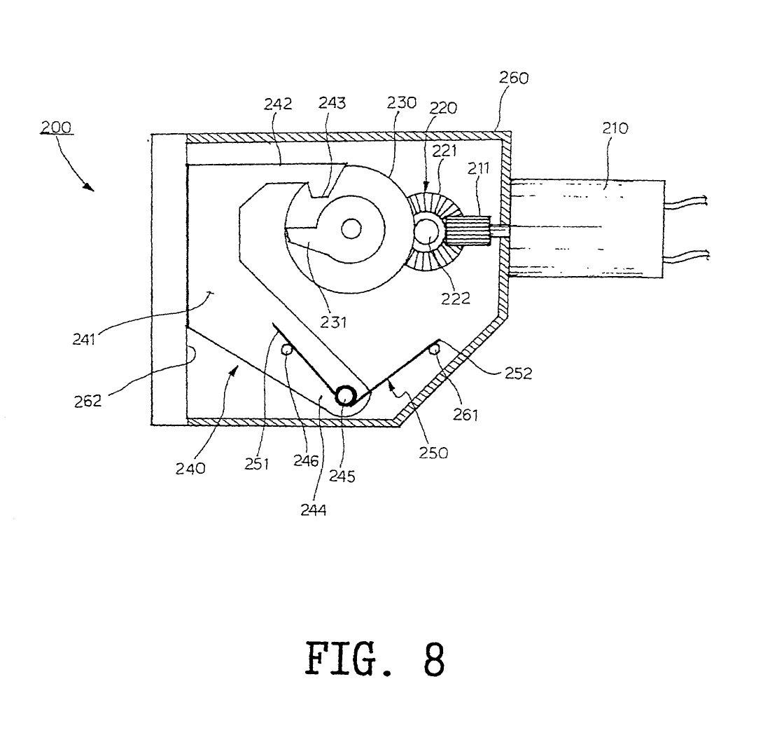

FIG. 7 is a perspective view of a shock generating device according to a preferred second embodiment of the present invention. Referring to FIG. 7, a shock generating device 200 is comprised of a driving motor 210 protruding inside from the outside of a housing 260, a first gear 211 fixed to a rotating shaft of the driving motor 210, a two-stepped gear 220 with a second gear 221 receiving the rotating force of the first gear 211 and a third gear 222 integrally formed with the second gear 221 around the same axis, a fourth gear 230 receiving the rotating force of the second and third gears 221 and 222, a hook 231 integrated coaxially with the fourth gear 230 and extended to the outer circumferential surface of the fourth gear 230, a lever 240 installed to be somewhat interfered by the rotation of the hook 231, and an elastic member 250 for applying a predetermined elastic force to the lever 240 so that one portion of the lever 240 contacts the inner wall (262 in FIG. 8) of the housing 260 in a normal state.

The lever 240 has a body 241 that contacts the inner wall (262 in FIG. 8) of the housing 260, a free end 242 extended from the body 241 to the rotating radius of the hook 231, and a fixed end 244 extended from the body 241 and rotatably fixed on the housing 260 by a hinge pin 245. The body 241, free end 242, and fixed end 244 are integrally formed.

The first and second gears 211 and 221 can transfer driving force through spur-bevel gear combination, helical-bevel gear combination, spiral-bevel gear combination, zerol-bevel gear combination, crown-spur gear combination, or helical crown-spur gear combination. That is, since the two-stepped gear 220 and the fourth gear 230 are installed on a side surface of the housing 260 in view of the nature of the housing 260, the first gear 211 and the second gear 221 can be a combination of gears with orthogonal axes.

Therefore, if the third gear 222 is a spur gear, the fourth gear 230 can be a spur gear engaged with the third gear 222.

The tip of the free end 242 is formed into a hooking portion 243 bent downward to be interfered by the hook 231 until the hook 231 rotates at a predetermined angle.

A torsion spring can be used as the elastic member 150, of which the center is fixed on the fixed end 244 by the hinge pin 245 and which has one end 251 pressing a support pin 246 formed on the lever and the other end 252 pressing a support pin 261 formed on the inner surface of the housing 260.

Meanwhile, a tension coil spring can also be used as the elastic member, which has one end fixed by a fixing pin protruding from the fixed end 244 and the other end fixed by a fixing pin formed at an appropriate position of the inner wall of the housing 260, for pulling the lever 240 down.

The lever 240 is formed of a heavy weight metal, preferably steel or copper resistant to rust in order to increase shocks resulting from bumping against the housing 260.

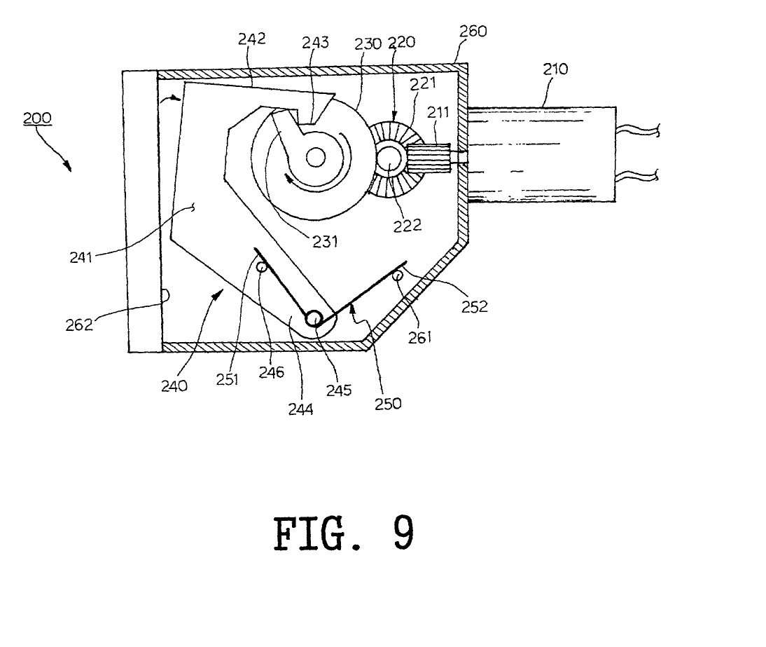

FIG. 8 is a sectional view of the shock generating device according to the second preferred embodiment of the present invention and FIG. 9 illustrates the shock generating operation of the shock generating device shown in FIG. 8. Referring to FIGS. 8 and 9, as the first gear 211 rotates upon receipt of the rotating force of the driving motor 210, the second gear 221 engaged with the first gear 211 rotates and then the third gear 222 rotates. As the third gear 222 rotates, the fourth gear 230 engaged with the third gear 222 rotates with the hook 231 installed coaxially with the fourth gear 230. At the same time, the hook 231 is hooked by the hooking portion 243 of the free end 242. If the hook 231 further rotates in an arrow direction shown in FIG. 9, the lever 240 with the hooking portion 243 hooking the hook 231 is pulled around the hinge pin 251 in the arrow direction of FIG. 9. Then, the torsion spring 250 in engagement with the lever 240 and the housing 260 stores predetermined elastic force.

Then, as the hook 231 further rotates, the hooking portion 243 momentarily slips off from the end portion of the hook 231 and the lever 240 returns to its original position by the restoring force of the torsion spring 250. Consequently, a side surface of a body 241 of the lever 240 bumps against the inner wall 262 of the housing 260, thereby producing shocks.

It is preferable to produce one shock when the hook 231 makes one revolution.

In accordance with the present invention as described above, the shock generating device for a simulation gun produces shocks electrically (automatically) upon switching of a trigger. Therefore, the present invention offers the benefits of reduced mechanical troubles and increased sense of real shooting in a shooting drill or a shooting game.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A shock generating device for a simulation gun, comprising:
a cylindrical housing;
a hollow rod inserted into the cylindrical housing;
a shaft installed in the lengthwise direction inside the housing movably along with the hollow rod and coaxially with the hollow rod;
a spring with predetermined elasticity having one end inserted into the hollow rod and the other end supported by a cap mounted on the housing and having a first opening for inserting the shaft therethrough, the spring biasing the shaft toward an inner lower surface of the cylindrical housing;
a driven gear integrated with a hollow cam shaft with a spiral inclined portion and mounted on the cap, and having a second opening for inserting the shaft thereinto;
a key fixedly protruding from the outer circumferential surface of the shaft perpendicularly to the axial direction, the key bearing upon the spiral inclined portion of the driven gear and moving the shaft in the length direction along the spiral inclined portion upon rotation of the hollow cam shaft; and
a driving device installed at a side of the housing and having a driving gear engaged with the driven gear.

2. The shock generating device of claim 1, further comprising:
a guide slit formed in the lengthwise direction on the outer circumferential surface of the shaft; and
a guide pin protruding inward from the inner wall of the housing, for being inserted into the guide slit to guide the axial direction movement of the shaft.

3. The shock generating device of claim 1, wherein the shaft is fixed to the hollow rod by a fixing pin to move with the hollow rod after the shaft is inserted into the hollow rod.

4. The shock generating device of claim 3, wherein the hollow rod has a spring insertion hole having a larger diameter than a hole for the shaft to receive pressure from the spring after the spring is inserted into the hollow rod.

5. The shock generating device of claim 1, wherein the hollow rod has a spring insertion hole having a larger diameter than a hole for the shaft to receive pressure from the spring after the spring is inserted into the hollow rod.

6. The shock generating device of claim 1, wherein the hollow cam shaft of the driven gear has a peak point at an end of the spiral incline portion and a falling portion connected to the peak point, so that as the driven gear rotates, the key of the shaft is guided from a bottom point to the peak point and then drops to the bottom point along the falling portion and thus the shaft reciprocates for a predetermined distance along the axial direction.

7. The shock generating device of claim 6, wherein when the key of the shaft moves from the peak point to the bottom point along the falling portion of the driven gear, an end portion of the hollow rod moving with the shaft under the elastic force of the spring impacts the inner lower surface of the housing.

8. The shock generating device of claim 7, wherein the driving device produces one shock as the driven gear makes one revolution by the driving gear when the gun is fired once.

9. The shock generating device of claim 1, wherein the driving device produces one shock as the driven gear makes one revolution by the driving gear when the gun is fired once.

10. The shock generating device of claim 1, wherein the driving device further includes a driving motor and a deceleration module having a plurality of gears in combination, for reducing the number of revolutions of the driving motor and increasing the rotating force of the driving motor.

11. The shock generating device of claim 10, wherein the cap mounted on the housing is integrally formed with a cap mounted on the deceleration module of the driving device so that the driven gear and the driving gear are engaged with each other on the caps and thus the driving device and the housing are assembled into a unitary structure.

12. The shock generating device of claim 1, wherein the cap mounted on the housing is integrally formed with a cap mounted on the deceleration module of the driving device so that the driven gear and the driving gear are engaged with each other on the caps and thus the driving device and the housing are assembled into a unitary structure.

13. The shock generating device of claim 1, wherein the hollow rod and the shaft are formed of a heavy weight metal to increase shocks produced when the hollow rod and the shaft impact against the housing.

14. The shock generating device of claim 1, wherein the spring is a compressed coil spring.

15. A shock generating device for a simulation gun, comprising:
a housing;
a driving motor outside the housing and having a rotating shaft protruding inside the housing;
a first gear fixed to the rotating shaft of the driving motor;
a two-stepped gear with a second gear receiving the rotating force of the first gear and a third gear integrally formed with the second gear around the same axis;
a fourth gear receiving the rotating force of the second and third gears;
a hook integrated coaxially with the fourth gear and extended to the outer circumferential surface of the fourth gear;
a lever having a body that contacts the inner wall of the housing, a free end extended from the body and engaged by the hook, and a fixed end extended from the body and rotatably fixed on the housing, the body, the free end, and the fixed end being integrally formed; and
an elastic member for pressing the body of the lever to contact the inner wall of the housing.

16. The shock generating device of claim 15, wherein the first gear of the driving motor and the second gear of the two-stepped gear transfer driving force through one of spur-bevel gear combination, helical-bevel gear combination, spiral-bevel gear combination, zerol-bevel gear combination, crown-spur gear combination, and helical crown-spur gear combination.

17. The shock generating device of claim 16, wherein the third gear is a spur gear and the fourth gear is a spur gear to be engaged with the third gear.

18. The shock generating device of claim 15, wherein the third gear is a spur gear and the fourth gear is a spur gear to be engaged with the third gear.

19. The shock generating device of claim 15, wherein the tip of the free end is formed into a hooking portion bent downward to be engaged by the hook until the hook rotates through a predetermined angle.

20. The shock generating device of claim 15, wherein the elastic member is a torsion spring, of which the center is fixed on the fixed end by a hinge pin of the fixing end of the lever and which has one end engaging a support pin formed on the lever and the other end engaging a support pin formed on the inner surface of the housing.

21. The shock generating device of claim 15, wherein the elastic member is a tension coil spring which has one end fixed by a fixing pin protruding from the fixed end of the lever and the other end fixed by a fixing pin formed on the inner wall of the housing, for biasing the lever toward the inner wall of the housing.

22. The shock generating device of claim 15, wherein the lever is formed of a heavy weight metal to increase shocks produced when the lever impacts against the housing.

23. An apparatus for simulating recoil in a simulation gun having a trigger that is grasped and pulled by a user to a firing position to simulate the firing of the simulation gun, comprising:
an impact surface disposed within the simulation gun and connected to the interior of the simulation gun such that movement of the surface results in a corresponding movement of the simulation gun;
an impact member moveable within the simulation gun and having sufficient mass such that impact of the member on the impact surface can cause movement of the simulation gun perceptible to the user of the simulation gun; and
an electromechanical drive mechanism operatively connected to the impact member to cause the impact member to reciprocate between a first position engaging the impact surface and a second position wherein the impact member is disengaged from the surface, the drive mechanism being adapted to drive the impact member in response to movement of the trigger toward the firing position to impact the impact surface and cause movement of the simulation gun perceptible to the user of the simulation gun.

24. The apparatus of claim 23, wherein the impact member moves linearly between the first position and the second position.

25. The apparatus of claim 23, wherein the impact member moves in a non-linear path between the first position and the second position.

26. The apparatus of claim 25, wherein the non-linear path is a circular arc.

27. The apparatus of claim 23, wherein the electromechanical drive mechanism comprises an electric motor.

28. The apparatus of claim 23, wherein the electromechanical drive mechanism moves the impact member through one cycle of reciprocating movement in response to each movement of the trigger to the firing position.
